(19) United States
(12) Patent Application Publication
(10) Pub. No.: US 2010/0095903 A1
(43) Pub. Date: Apr. 22, 2010

(54) Pet belt

(76) Inventor: Roy Garcia, Oxnard, CA (US)

Correspondence Address: JAMES RAY & ASSOCIATES, 2640 PITCAIRN ROAD, MONROEVILLE, PA, 15146, US

(21) Appl. No.: 12/288,197

(22) Filed: Oct. 17, 2008

(51) Int. Cl. A62B 35/00

(52) U.S. Cl. 119/770

(57) ABSTRACT

A belt is worn by user to allow the hands free walking of a pet by attaching a leash or leashes to a ring attached at a predetermined location on the belt. The belt has pouches at a predetermined location for the improved storage of cell phone, mp3 player and preferably a plurality of pouches for the accessible storage of pet accessories and water bottle.

### CROSS REFERENCE TO RELATED APPLICATION

This patent application is related to and claims priority from U.S. Provisional Patent Application Ser. No. 60/979,638 filed Oct. 17, 2007.

### FIELD OF THE INVENTION

The present invention relates, in general, to a hands free leash and, more particularly, this invention relates to a combination belt, leash and storage for items related to pet and human.

### BACKGROUND OF THE INVENTION

Prior to the conception and development of the present invention, as is generally well known in the prior art, a belt having a leash attached to the belt. Also, known in the prior art are leashes that are slidably attached to belts. Other belts have rings to hold multiple leashes.

Other belts have pouches for water bottles and pouches. However, the prior art does not accommodate the storage pouches, water bottle, mp3 player, cell phone and multiple leashes.

### SUMMARY OF THE INVENTION

The present invention provides a belt with opposing ends preferably with quick release connectors male and female attached to the respective opposing ends. The belt preferably has a conventional adjuster a predetermined location on the belt to adjust the length of the belt to accommodate the user. The belt is preferably manufactured of nylon, but may also me made of other materials such as fabric, plastic or leather.

The belt has at least one pouch and preferably a plurality of pouches. The pouches preferably are attached to the belt by sewing, but may also be attached by other attaching means such as rivets or thermal welds. The pouches may be attached directly to the belt or may be attached to an intermediate material such as such as fabric, plastic or nylon. The pouch is attached to the material and the material is attached to the belt by the means mentioned above. The pouches preferably have a closure such as a snap or hook and loop fastener.

The belt preferably has preferably at least one pouch with a mesh portion that is detachable for cleaning. Also, the belt has preferably a pouch that has a predetermined shape and depth to receive a bottle.

Preferably, the belt has two pouches generally adjacent to the ends of the belt with a predetermined location. These pouches have a predetermined height, width and depth to accommodate consumer electronics such as a cell phone, mp3 player or camera. Preferably the pouches generally adjacent to the ends of the belt have padding to protect the consumer electronics.

The belt has at least on ring attached preferably by a nylon loop sewn to the belt at a predetermined location. The rings may be attached by loops of other material as well. Preferably the belt has two rings at predetermined locations at predetermined distance from opposing ends of the belt.

The rings have a clasp such as a carabineer that releasably attaches to the ring and accommodates a leash or leashes.

### OBJECTS OF THE INVENTION

It is, therefore, one of the primary objects of the present invention to provide an improved hands free belt for walking pets.

Another object of the present invention is to provide a hands free belt that has storage capacity for water, pet toys and food.

Still another object of the present invention is to provide a hands free belt that will accommodate more than one leash.

Yet another object of the present invention is to provide a

An additional object of the present invention is to provide a hands free belt that carries consumer electronics safely.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a perspective drawing of the belt.

FIG. 2 is a partial perspective view of the ring and loop

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components that have identical functions have been identified with identical reference numerals throughout the several views illustrated in the drawing figures.

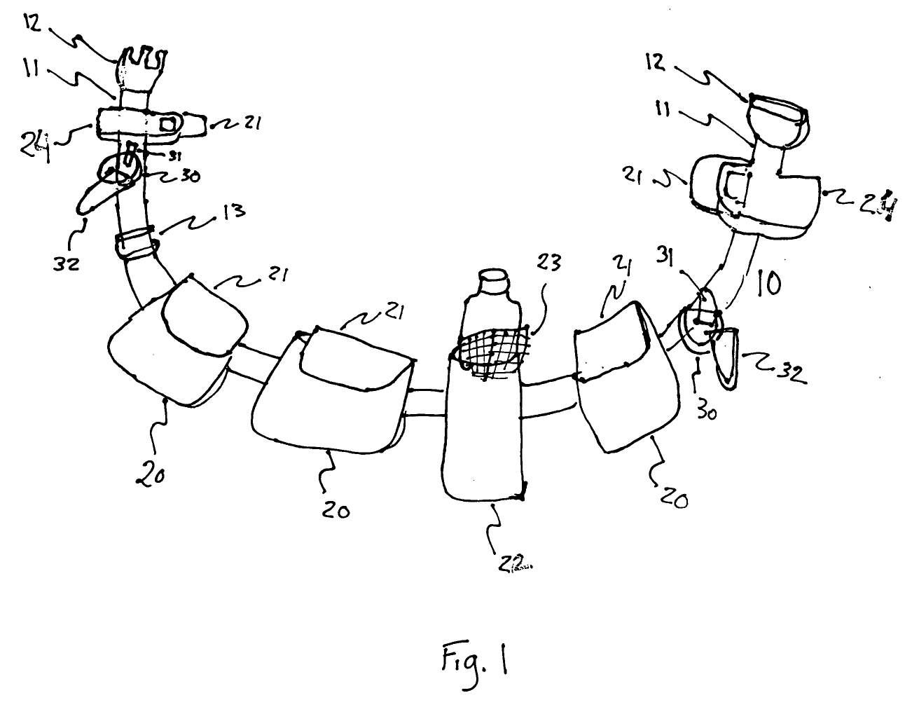

Reference is now made, more particularly, to FIG. 1, the belt 10 has opposing ends 11 with a connecting means preferably with male and female quick release connectors 12.

The belt 10 has an adjuster 13 at a predetermined location on the belt. The belt is preferably manufactured of nylon, but may also me made of other materials such as fabric, plastic or leather.

The belt has at least one pouch and preferably a plurality of pouches. The pouches preferably have a flap 21 and a closure (not shown) The closure is preferably one of a snap or hook and loop fastener. Preferably, at least one of the pouches 22 has a predetermined shape and depth to receive a bottle. Also, preferably at least one pouch has a mesh portion 23.

Preferably, two of the pouches are generally adjacent to the opposing ends 11 of the belt 10 are consumer electronics pouches 24. Pouches 24 preferably having a predetermined height width and depth to receive cell phones, mp3 players, cameras and the like.

The pouches 20, 22 and 24 preferably are attached to the belt 10 by sewing, but may also be attached by other attaching means such as rivets or thermal welds. The pouches 20, 22 and 24 may be attached directly to the belt 10 or may be attached to an intermediate material such as such as fabric, plastic or nylon. The pouch is attached to the material and the material is attached to the belt by the means mentioned above.

FIG. 1 shows belt 10 has at least one ring 30 attached preferably by a nylon loop 31 sewn to the belt 10 at a predetermined location. Rings 30 may be attached by loops 31 of other material as well. Preferably the belt has two rings 30 at predetermined locations at predetermined distance from opposing ends 11 of the belt 10.

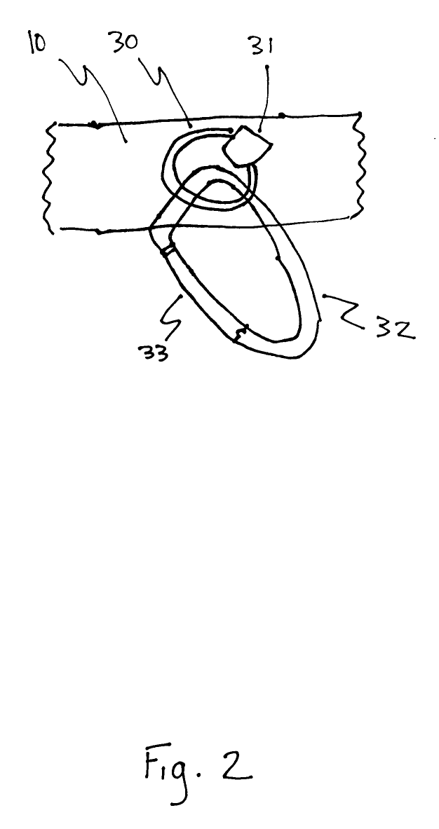

FIG. 2 shows the respective rings 30 have a clasp 31 such as a carabineer or clip that releasably attaches to the ring 30. The clasp 31 has portion 33 that pivots to open and is biased to close. The clasp 32 and accommodates a leash or leashes.

It has been found that by attaching the consumer electronics pouches 24 generally adjacent to the opposing ends 11 of belt 10, that the use of the electronics is more convenient and the electronics are better protected than other configurations. Further, the prior art generally attached leashes to the front portion of the belt as worn by the user or allowed the leash to slide around the belt. It has been found that that by attaching the rings 30 to generally the side of the user that the access to the storage pouches is enhanced while permitting the user to walk the pet without interference.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. A hands free pet belt releasably attached to a user for receiving a pet leash comprising:
a belt having a first end and a second end;
a releasable connecting means at each of said ends;
at least one pouch attached by a first attaching means to said belt;
at least one ring attached to said belt by a second attaching means; and
a second connecting means releasably connected to said ring and such leash.

2. A belt according to claim 1 wherein said connecting means is one of quick release buckle, hook and loop fastener, and conventional buckle.

3. A belt according to claim 1 wherein said first attaching means is one of material sewn, riveted and thermally welded to said belt and said at least one pouch.

4. A belt according to claim 3 wherein said material is one of nylon, thermoplastic, fabric and leather.

5. A belt according to claim 1 wherein said first attaching means is one of sewing, riveting and thermally welding said belt to said at least one pouch.

6. A belt according to claim 1 wherein said second attaching means is one of fabric sewn, riveted and thermally welded to said belt, said fabric around said least one ring.

7. A belt according to claim 6 wherein said fabric is one of nylon and thermoplastic.

8. A belt according to claim 1 wherein said first attaching means is one of sewing, riveting and thermally welding said belt to said at least one ring.

9. A belt according to claim 1 wherein said at least one pouch has a closure means.

10. A belt according to claim 9 wherein said pouch closure means is one of a snap, hook and loop and button and hole.

11. A belt according to claim 1 wherein said at least one pouch having a detachable mesh portion.

12. A belt according to claim 1 having a plurality of pouches.

13. A belt according to claim 1 wherein said at least one pouch having a predetermined length width and depth to receive a cell phone.

14. A belt according to claim 1 wherein said at least one pouch having a predetermined length width and depth to receive an mp3 player.

15. A belt according to claim 1 wherein said at least one pouch having a predetermined length width and depth to receive a camera.

16. A belt according to claim 1 wherein said at least one pouch is padded.

17. A belt according to claim 1 wherein said has an adjusting means a predetermined location on the said belt.

18. A belt according to claim 1 wherein said second connecting means is one of a clip, carabineer and clasp.

19. A hands free pet belt releasably attached to a user for receiving a pet leash comprising:
a belt having a first end and a second end;
a releasable connector, male and female attached at each of said respective belt ends;
a plurality of pouches attached to said belt, at least one of said pouches attached generally adjacent to said end of said belt having a predetermined height, width and depth;
at least one ring attached to said belt by a loop attaching; and
a clasp releasably connected to said ring and such belt.

20. A belt according to claim 19 wherein at least one of the pouches has a detachable mesh portion.
